(19) United States
(12) Patent Application Publication
(10) Pub. No.: US 2005/0169261 A1
(43) Pub. Date: Aug. 4, 2005

(54) Method of signaling the length of OFDM WLAN packets

(75) Inventors: Richard G. C. Williams, Santa Rosa, CA (US); A. Joseph Mueller, San Diego, CA (US); Stephen P. Pope, Berkeley, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/911,843

(22) Filed: Aug. 5, 2004

Related U.S. Application Data
(60) Provisional application No. 60/541,513, filed on Feb. 3, 2004.

(51) Int. Cl. H04L 12/54

(52) U.S. Cl. 370/389

(57) ABSTRACT

A system 100 for wireless communication is provided. The system 100 includes first communication device 110A operable to transmit a message 300 according to a new protocol. The new protocol having a header 302 including a first rate field and a first length field, a header extension 304 including a second rate field and a second length field, and a data 306. When the message 300 is received by a legacy communication device 102 which is operable to receive a portion of the message 300 according to a legacy protocol, the legacy communication device 102 refrains from transmitting for a duration indicated by the combination of the first rate field and the first length field. The system 100 also includes a second communication device 110B operable to receive the message 300 according to the new protocol. A method of communicating to maintain compatibility with legacy devices is also provided.

### CROSS-REFERENCE TO RELATED APPLICATIONS

This application claims the benefit of U.S. Provisional Patent Application Ser. 60/541,513 filed on Feb. 3, 2004, naming Williams et al. inventors, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to wireless local area network communication protocols, and more particularly, but not by way of limitation, to a method for signaling the length of orthogonal frequency division multiplexing wireless local area network packets.

### BACKGROUND OF THE INVENTION

Systems are continuously being developed that permit electronic devices to communicate with each other without a wired connection. In order for the devices to communicate, a wireless protocol (i.e., standard) may be used to define hardware and software parameters such that the devices are able to send, receive, and interpret data. For example, the IEEE-802.11 standard is provided by the Institute of Electrical and Electronics Engineers (IEEE) and describes medium access control (MAC) and physical layer specifications that may be used for wireless local area networks (WLANs). While existing wireless standards allow electronic devices to communicate, it is desirable to increase the data transfer rate between electronic devices to provide improved performance and capabilities to wireless systems.

### SUMMARY OF THE INVENTION

The present disclosure, according to one embodiment, provides a system for wireless communication. The system includes first communication device operable to transmit a message according to a new protocol. The new protocol having a header including a first rate field and a first length field, a header extension including a second rate field and a second length field, and a data field. When the message is received by a legacy communication device which is operable to receive a portion of the message according to a legacy protocol, the legacy communication device refrains from transmitting for a duration indicated by the combination of the first rate field and the first length field. The system also includes a second communication device operable to receive the message according to the new protocol.

In one embodiment, a protocol to enable improved wireless communication between new devices and to maintain compatibility with legacy devices is provided. The protocol includes a header portion, a header extension, and a data portion. The header portion including a first rate field and a first length field. The first rate and length fields operable to indicate a duration of a message such that a legacy device refrains from transmitting for the duration indicated by the combination of the first rate field and the first length field. The header extension portion includes a second rate field and a second length field. The second length field indicates the number of octets in a last symbol period of the message. The combination of the second rate field, the second length field, and the duration of the message is operable to indicate a structure of the message. The data portion contains an information content of the message.

In another embodiment, a method of communicating to maintain compatibility with legacy devices is provided. The method includes creating a header extension containing a first rate field and a first length field of a message according to a first protocol. The method also includes creating a header containing a temporal length of the message according to a second protocol. The method further provides for sending the message including the header and the header extension to a first device operable to receive the message according to the first protocol and to a second device operable to receive at least a portion of the message according to the second protocol.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a wireless system in accordance with embodiments of the invention.

FIG. 2 illustrates a data packet used for wireless communication.

FIG. 3 illustrates a data frame in accordance with embodiments of the invention.

FIG. 4 illustrates a method for generating a message including a header and a header extension in accordance with embodiments of the invention.

FIG. 5 illustrates a method for receiving a message including the header and the header extension in accordance with embodiments of the invention.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

Electronic devices that communicate wirelessly may use a variety of techniques to prepare, send, receive, and recover data. For example, data preparation techniques may comprise data scrambling, error correction coding, interleaving, data packet formatting, modulation, and/or other techniques. To send the data, one or more carrier frequencies may be selected and one or more antennas may propagate a wireless signal at the selected carrier frequency(s). To receive the data, one or more antennas may “pick up” the wireless signal, after which the data may be recovered using techniques such as signal amplification, digitization, down-sampling, equalization, demodulation, de-interleaving, de-coding, and/or de-scrambling.

The processes of preparing, sending, receiving, and recovering data as described above may be organized to permit multiple devices to interactively communicate in real-time. During this interaction between multiple devices, there is an ongoing need for efficient data traffic control. For example, if all of the devices of a wireless system send data at the same time, none of the devices may be able to receive data. There are many methods and implementations for providing data traffic control. Some methods of data traffic control may comprise allocating pre-determined time intervals to each device of a wireless system during which each device has an opportunity to send data to another device. Additionally or alternatively, some methods may rely on a contention protocol in which devices attempt to communicate on an as-needed basis. Such methods may provide information (e.g., data transfer rate, amount of data) in each wireless data packet that permits all devices of a wireless system to estimate when a current data transmission will be finished, after which another data transmission may occur.

Another aspect of wireless communication may include providing methods that permit devices which implement different wireless protocols to communicate with each other or at least coexist with each other. As will be described herein, embodiments of the invention may comprise a wireless system, wherein at least one device of the system uses a first protocol and at least one device of the system uses a second protocol. In at least some embodiments, the devices that use the first protocol may communicate with each other using a different (e.g., lower) data transfer rate than the devices that communicate using the second protocol. Additionally, embodiments of the invention may allow devices that use the first protocol to communicate with devices that use the second protocol and vice versa. Additionally, embodiments of the invention may allow devices that use the first and second protocols to efficiently coordinate data traffic control (e.g., clear channel assessment mechanisms).

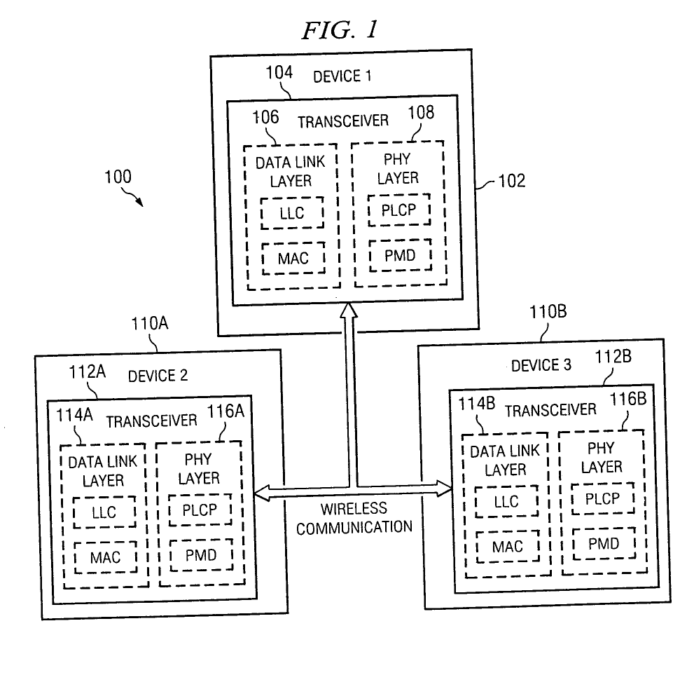

FIG. 1 illustrates a wireless system 100 in accordance with embodiments of the invention. As shown in FIG. 1, the wireless system may comprise the devices 102, 110A, and 110B. The device 102 may comprise a transceiver 104 having a data link layer 106 and a physical (PHY) layer 108. In at least some embodiments, the device 102 may implement a first wireless protocol (e.g., 802.11a, 802.11g). Similarly, each of the devices 110A and 110B also may comprise a transceiver 112A, 112B having a data link layer 114A, 114B and a PHY layer 116A, 116B. In at least some embodiments, the devices 110A and 110B may be implement a second wireless protocol (e.g., 802.11n).

In at least some embodiments, the devices 110A and 110B may communicate with each other using a data transfer rate that is not supported by the first protocol implemented by the device 102. For example, if the first protocol is 802.11a/g, the defined data transfer rates may be described by the Table 1 shown below.

TABLE 1

| Data Rate (Mbps) | Modulation |
|---|---|
| 6 | BPSK |
| 9 | BPSK |
| 12 | QPSK |
| 18 | QPSK |
| 24 | 16-QAM |
| 36 | 16-QAM |
| 48 | 64-QAM |
| 54 | 64-QAM |

As previously described, the first and second protocols may use different data rates to transmit data. Additionally, the second protocol may use different modulations and/or combinations of data rates and modulations than those used by the first protocol. For example, in at least some embodiments, the second protocol may define data rates and associated modulation according to the Table 2 shown below.

TABLE 2

| Data Rate (Mbps) | Modulation |
|---|---|
| 6 | BPSK |
| 9 | BPSK |
| 12 | QPSK |
| 18 | QPSK |
| 24 | 16-QAM |
| 36 | 16-QAM |
| 48 | 16-QAM |
| 72 | 16-QAM |
| 54 | 64-QAM |
| 96 | 64-QAM |
| 108 | 64-QAM |
| 126 | 64-QAM |
| 140 | 64-QAM |

As shown in Table 1 and Table 2, the data rate and modulation definitions used for the first and second protocols may not be compatible. Therefore, embodiments of the invention preferably provide methods and systems that permit the devices 110A, 110B to transmit data to each other according to the second protocol, and permit the devices 110A, 110B to transmit data to the device 102 using the first protocol and vice versa. Additionally, embodiments of the invention may permit the devices 102, 110A, and 110B to estimate/determine the duration of data transfers according to data rates supported by either the first protocol or the second protocol.

In order for the devices 102, 110A, and 110B to communicate wirelessly, the PHY layers 108, 116A, 116B and the data link layers 106, 114A, 114B may perform several functions. For example, the PHY layers 108, 116A, 116B may each implement a physical layer convergence procedure (PLCP) sub-layer and a physical medium dependent (PMD) sub-layer. The PLCP sub-layer may provide an interface whereby carrier sense and clear channel assessment (CCA) signals are provided to the data link layer 106, 114A, 114B indicating whether the PHY layer 108, 116A, 116B is in use. The PMD sub-layer may provide encoding, decoding, modulation, and/or demodulation of data. The PMD sub-layers also may provide analog-to-digital and/or digital-to-analog data conversion.

The data link layer 106, 114A, 114B may implement a logical link control (LLC) and a medium access control (MAC). During transmission of data, the LLC may assemble data into a frame with address and cyclic redundancy check (CRC) fields. During reception of data, the LLC may disassemble a data frame, perform address recognition, and perform CRC validation. The MAC may function, at least in part, to coordinate transmission of data between the electronic devices 102, 110A, and 110B.

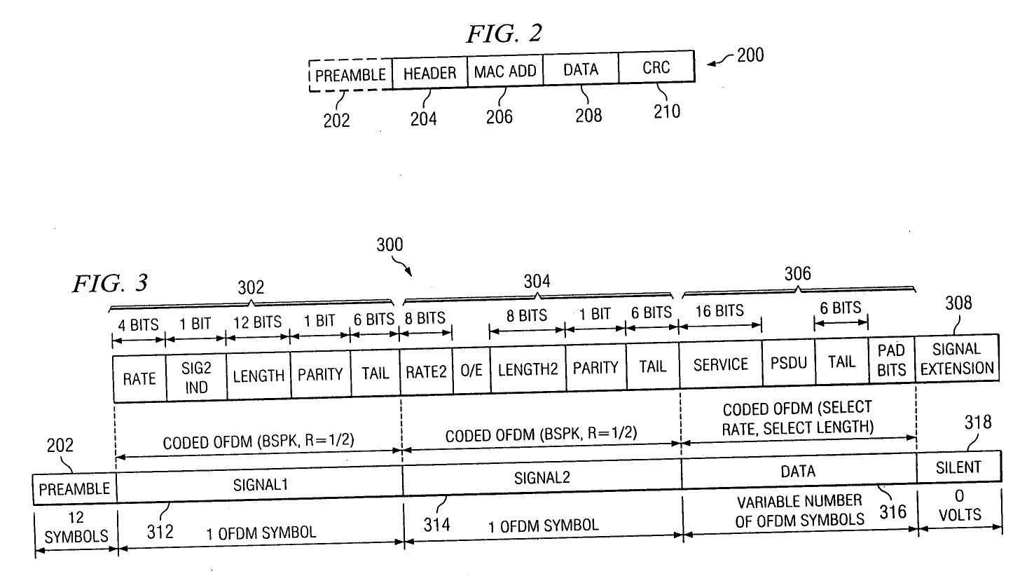

FIG. 2 illustrates an exemplary data packet 200 used for wireless data transmission. As shown in FIG. 2, the data packet 200 may comprise a preamble 202, a header field 204, a MAC address field 206, a data field 208, and a CRC field 210. The preamble 202 may be used for synchronization and channel estimation. The header field 204 may provide modulation information, convolution coding rate information, and data length (i.e., number of octets) information. The MAC address field 206 may comprise a hardware address that identifies a node of a network. The data field 208 may comprise a variable amount of scrambled data. The CRC field 210 may comprise information for detecting data transmission errors.

In accordance with at least some embodiments of the invention, one or more fields of a data packet 200 may be added and/or modified in order to permit the devices 110A, 110B to transmit data to each other according to the second protocol, and permit the devices 110A, 110B to transmit data to the device 102 using the first protocol and vice versa as previously described. Additionally, adding and/or modifying fields of a data packet 200 may permit the devices 102, 110A, and 110B to estimate the duration of data transfers (used for CCA) according to data rates supported by either the first protocol or the second protocol.

FIG. 3 illustrates a data frame 300 in accordance with embodiments of the invention. In some embodiments, the data frame 300 may comprise a modified PPDU (PLCP Protocol Data Unit) frame. As shown in FIG. 3, the data frame 300 may comprise a header 302 (e.g., a PLCP header), a header extension 304, and data 306 (e.g. PSDU (PLCP Service Data Unit) data). A MAC address frame (not shown) also may be included before or in the data 306.

The header 302 may comprise a single OFDM (Orthogonal Frequency Division Multiplexing) symbol 312 denoted as “SIGNAL1”. In at least some embodiments, the header 302 may define fictitious information for interpretation by devices that are not compatible with the header extension 304 or other parameters of a protocol. The purpose of the fictitious information will later be described. The SIGNAL1 symbol 312 described above may be transmitted at a rate of 6 megabits per second (Mbps) using binary phase shift keying (BPSK) and a coding rate of ½. As shown in FIG. 3, the SIGNAL1 symbol 312 may comprise data from a “RATE” field, a “SIG2 IND” field, a “LENGTH” field, a “PARITY” field, and a “TAIL” field. The RATE field may comprise 4 bits of data that identify a data rate having a fixed type of modulation (e.g., BPSK, QPSK, 16-QAM, 64-QAM) and/or a convolutional coding rate (e.g., ½, ¾, ⅔). In at least some embodiments, the RATE field also may contain information that defines a transmission antenna configuration. The SIG2 IND field may comprise 1 bit of data that identifies whether the header extension 304 will be used (i.e., the SIG2 IND field may be used as a flag that indicates when the header extension 304 is used). Alternatively, other methods may be used to determine whether the header extension 304 is used. For example, a “stealth” signal may be transmitted with the header frame 302 using the quadrature component of the signal subcarrier. The stealth signal may be detectable by devices (e.g., devices 110A and 110B) that can interpret the header extension 304 and undetectable to devices (e.g., device 102) that cannot interpret the header extension 304. Alternatively, the stealth signal may be detectable by devices (e.g., device 102) other than those that use the second protocol, in which case the stealth signal, preferably, does not interfere with the normal operation of the non-second protocol device. The LENGTH field may comprise 12 bits of data that identify a number of octets used for the data 306. The PARITY field may comprise 1 bit that identifies a positive parity bit for bits (0-16) of the header 302. The TAIL field may comprise 6 bits used to bring a convolutional encoder to a zero state.

The header extension 304 may be used when the SIG2 IND field bit of the header 302 is asserted (i.e., equal to a logical “1”). As shown, the header extension 304 may comprise a single OFDM symbol 314 denoted as “SIGNAL2”. In at least some embodiments, the header extension 304 may define information regarding parameters used by the second protocol. The SIGNAL2 symbol 314 described above may be transmitted at a rate of 6 Mbps using BPSK and a coding rate of ½. The header extension 304 may comprise a “RATE2” field, a “LENGTH2” field, a “PARITY” field, and a “TAIL” field. The RATE2 field may comprise 8 bits that define a data transfer rate of a second protocol and a corresponding modulation type, coding rate and/or antenna configuration.

To provide compatibility with the first protocol, the length of the data 306 may be constrained to be an integer multiple of approximately 4 μS symbol periods in duration. In order to ensure that the length of the data 306 conforms to this restriction, an extension may be added to extend the length of the data 306 to be an integer multiple of approximately 4 μS in duration. The extension of the length of the data 306 may be empty octets or silence. The last approximately 4 μS symbol period may typically contain less than the maximum number of octets. The LENGTH2 field may comprise 9 bits that define the number of octets contained in the last approximately 4 μS symbol period. The PARITY field may comprise 1 bit that identifies a positive parity bit for bits (0-16) of the header extension 304. The TAIL field may comprise 6 bits (e.g. all “0s”) used to bring a convolutional encoder to a zero state. In accordance with at least some embodiments, one or more header extensions 304 may be added to a data frame 300 to define different modulations, coding rates, antenna configurations, and/or data rate mappings.

The field bit lengths described above are exemplary. In other embodiments other bit lengths for the fields may be employed. For example, in an embodiment, the RATE2 field may comprise 5 bits, and the LENGTH2 field may comprise 12 bits.

In an embodiment it may be desirable in the second protocol to employ symbol periods other than the approximately 4 μS symbol period, and bits may be reallocated to encoding the symbol period. If an approximately 2 μS symbol period is employed, an “O/E” field, signifying odd or even, comprising 1 bit to represent that the number of octets in the data 306 is odd or even. The knowledge of whether an odd or even number of octets are contained in the data 306 combined with the information about the number of octets in the last symbol period contained in the LENGTH2 provide sufficient information to the devices 110A and 110B to receive the data 306.

The data 306 may comprise a “SERV” field, a “PSDU” field, a “TAIL” field, and a “PAD BITS” field. The SERV (i.e., service) field may comprise 16 bits used to synchronize a descrambler in a receiver (e.g., transceiver 104A, 104B). The PSDU field may comprise a variable amount of data. The TAIL field may comprise 6 bits used to bring a convolutional encoder to a zero state. The PAD BITS field may comprise a one or more bits (e.g., all “0s”) that extend the length of the PSDU data 306 to be a multiple of the number of data bits per OFDM symbol (N_{DBPS}). In at least some embodiments, the N_{DBPS} may be calculated as:
N_{DBPS}=(Data Transfer Rate)*(3.2+T_{GI}) (1)

In equation (1), the Data Transfer Rate may comprise a data rate defined by the RATE field or the RATE2 field, and the TGI value may comprise a time allocated for a guard interval (i.e., a time interval between symbols for reducing inter-symbol interference).

As shown in FIGS. 2 and 3, the data frame 300 may also comprise a preamble 202 and a signal extension 308, 318. The preamble 202 may comprise a number of symbols (e.g., 12 symbols) that are used for synchronization and channel estimation. The signal extension 308 may comprise a time period of silence (i.e., no data is transmitted) that provides a receiving system with additional time to decode the data 306 before receiving another data frame 300. For example, the signal extension time period may comprise approximately 4 μs.

Using the data frame 300 described above with suitable data link layers (e.g., data link layers 106, 114A, 114B) and/or PHY layers (e.g., PHY layers 108, 116A, 116B) allows devices (e.g., 102, 110A, 110B) of a wireless system (e.g., system 100) to calculate the duration of data transfers in accordance with a first protocol or a second protocol.

In at least some embodiments, the devices 110A and 110B may create and interpret a data frame 300 as part of the second protocol. Additionally, the second protocol may permit the devices 110A and 110B to interpret data frames that do not include the header extension 304 (e.g., data frames sent from the device 102). The device 102 may create and interpret data frames that do not include the header extension 304 in accordance with a first protocol. In at least some embodiments, the device 102 is unaware of header extensions 304 and may interpret a header extension 304 as the first OFDM symbol in the data field 208. Therefore, when a first protocol device (e.g., device 102) receives a second protocol data packet (e.g., data frame 300), the first protocol device may interpret the data packet up to and including the first header (which enables the first protocol device to determine the duration of the packet) and will attempt, but fail, to decode the remainder of the data packet. However, the first protocol device (e.g., device 102) will maintain silence for the duration of the packet and hence will not interfere with the transmission of the data packet formatted according to the second protocol.

The fictitious information in the header 302 provides an indication of the temporal length or duration of the data frame 300. In an embodiment, the header 302 may provide an indication of the temporal length or duration of the header extension 304 and the data 306. The duration may be determined from the combination of the information carried in the RATE field and the information carried in the LENGTH field. For example, in an embodiment, the device 102 may calculate the duration in seconds as:
duration=(LENGTH/RATE)*( 8/1,000,000) (2)
In equation (2), duration is expressed in units of seconds, LENGTH is expressed as a number of octets, and RATE is expressed in units of Mbps. The numerical constant ( 8/1,000,000) is employed to conform units. Specifically, the 1/1,000,000 factor converts Mbps to bps, and the 8 factor converts octets to bits. In the case that the devices 110A and 110B transmit at a rate or according to a modulation method unknown to the device 102, a rate known to the device 102 is encoded in the RATE field.

The number of octets encoded in the LENGTH field is determined by the rate encoded in the RATE field and by the duration. In an embodiment, this number of octets may be calculated by the transmitting devices 110A and 110B as:
length=(duration)*(RATE)*( 1,000,000/8) (3)
In equation (3), length is expressed as numbers of octets, the duration is expressed in units of seconds, and the RATE is expressed in units of Mbps. The numerical constant ( 1,000,000/8) is employed to conform units. Specifically, the 1,000,000 factor converts Mbps to bps, and the ⅛ factor converts bits to octets.

The information is said to be fictitious, in this case, because neither the RATE field nor the LENGTH field contain accurate information. The use of the fictitious information, however, permits the devices 110A and 110B to transmit in the presence of the device 102.

Because the fictitious information does not provide accurate information in the RATE field and the LENGTH field of the header 302, additional information must be provided in the header extension 304 to permit the devices 110A and 110B to determine the actual rate and length of the data frame 300. The accurate representation of duration or temporal length in the header 302 may be used to minimize the number of bits required to convey this information in the header extension 304. When the accurate encoding rate is provided in the RATE2 field enough information is available to determine the number of octets when all the symbols in the data frame 300 are full. In this case, in an embodiment, the maximum number of octets may be calculated as:
max octets=(duration)*(RATE2)*( 1,000,000/8) (4)
In equation (4), duration is expressed in units of seconds and may be calculated using equation (2) or by some other method of calculation. RATE2 is expressed in units of Mbps. The numerical constant ( 1,000,000/8) is employed to conform units. Specifically, the 1,000,000 factor converts Mbps to bps, and the ⅛ factor converts bits to octets.

When the last symbol is not full, as for example when two octets are provided in the last symbol when using a 6 Mbps encoding rate, the above calculation of max octets must be adjusted with the information of the LENGTH2 field, the number of octets in the last symbol. In an embodiment, the calculation of octets may be expressed generally as:
octets=((duration−SP)*RATE2)*( 1,000,000/8)+LENGTH2 (5)
In equation (5), SP is a numeric constant representing the duration of the symbol period expressed in units of seconds, duration is expressed in units of seconds, RATE2 is expressed in units of Mbps, and LENGTH2 is expressed as number of octets. The numerical constant ( 1,000,000/8) is employed to conform units. Specifically, 1,000,000 converts Mbps to bps, and ⅛ converts bits to octets.

Other methods of obtaining the results of equation 2, equation 3, equation 4, and equation 5 may readily occur to one skilled in the art, and all these methods are contemplated by the present disclosure.

In an embodiment, the value stored in the LENGTH2 field represents the total number of octets sent in the data frame 300 modulo a number, such as modulo 256. In an alternate embodiment, the value stored in the LENGTH 2 field represents the total number of octets sent in the extension header 304 and the data 306 modulo a number, such as modulo 256. The integer operation X modulo Y, where X is an integer and where the integer Y is called the modulus, may be defined to be the remainder left over when dividing X by Y. For example:
4 modulo 2=0, 5 modulo 2=1, 6 modulo 2=0
13 modulo 4=1, 14 modulo 4=2, 15 modulo 4=3, 16 modulo 4=0
   In some embodiments, it may be preferable that the modulus be a positive integer power of 2. In this embodiment, the LENGTH2 field may represent the least significant bits (LSBs) of the total number of octets sent in the data frame 300, the most significant bits (MSBs) of the total number of octets sent in the data frame 300 may be obtained from the duration, and the total number of octets in the data frame 300 may readily be calculated by several methods known to one skilled in the art. In an embodiment, one exemplary method of calculating total number of octets in the data frame 300 may be given as:
   total octets=[(max octets)DIV(modulus)]*modulus+(the value in the LENGTH2 field) (6)
   where the value of (max octets) is calculated with equation (4) above, where DIV is the integer division operation and where the DIV operation is performed before the multiplication operation. Note that during the integer division operation, DIV, any remainder is discarded. Thus, for example, the result of 5 DIV 2 is 2, and the result of (5 DIV 2)*2 where the DIV operation is performed before the multiply operation is 4.

Because the purpose of the RATE field and the LENGTH field in the header 302 of the data frame 300 is to indicate the duration of the data frame 300, or alternately to indicate the duration of the header extension 304 and the data 306, and because several values of the LENGTH field may result in the same duration indication, bits may be reclaimed from the header 302 and used for other purposes, such as further defining communication parameters according to the second protocol.

For example, if a 6 Mbps encoding rate is indicated in the RATE field and a length of 31 octets is indicated in the LENGTH field, the duration, based on an approximately 4 μS symbol period, is approximately 44 μS. In this case there are 11 symbol periods, and the last symbol contains one octet and two silent or empty octets. The duration is also approximately 44 μS for a length of 32 octets, and 33 octets. In the case of a length of 32 octets, there are 11 symbol periods, and the last symbol contains two octets and one silent or empty octet. In the case of a length of 33 octets, there are 11 symbol periods, and the last symbol contains three octets and zero silent or empty octets. As the rate indicated in the RATE field increases, and the possible number of octets contained in the last symbol period increases, the number of bits which can be reclaimed in the LENGTH field increases. The number of bits which can be reclaimed may be calculated as:
Reclaimed bits=floor(log₂(b/8)) (7)
In equation (7), b is the number of bits in the symbol period and the output of the floor function is the highest integer that is lower than or equal to the input. The log₂( ) function is the base 2 logarithm function. Dividing b by 8 converts from bits to octets, which is the unit of expression associated with the LENGTH field. The reclaimed bits may be the low order bits of the LENGTH field.

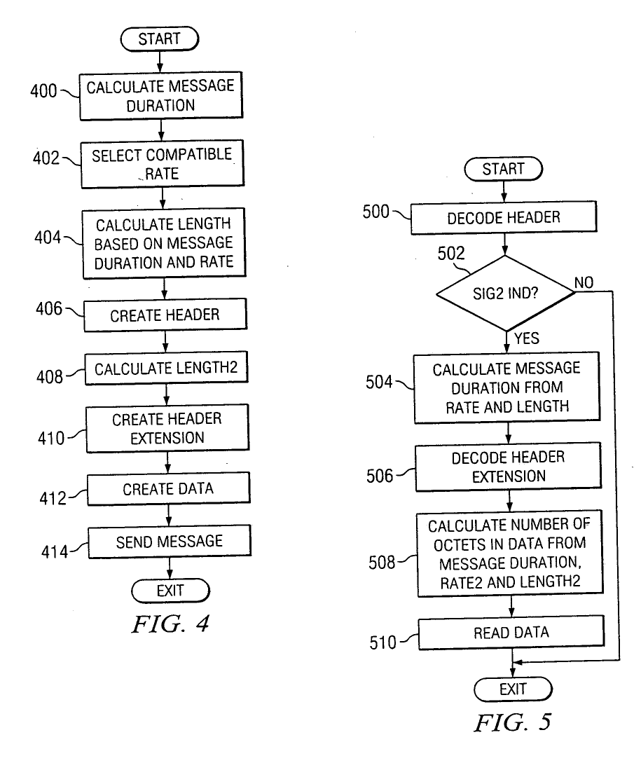

Turning now to FIG. 4, a flow chart of a method for generating and sending the message 300 according to one embodiment is depicted. In block 400 the device 110A or 110B calculates the duration of the message 300. To calculate this duration, the device 110A or 110B determines the desirable data transmission rate, how many octets of data are to be transmitted, and how many symbol periods are required to send the data.

The method proceeds to block 402 where the device 110A or 110B chooses a rate known in the first protocol to encode in the RATE field. In an embodiment, the highest rate known in the first protocol may be chosen to maximize the reclaiming of bits in the LENGTH field, as described above. The method proceeds to block 404 where the information to be encoded in the LENGTH field of header 302 is calculated based on the duration of the message 300 and the information encoded in the RATE field of the header 302. Recall that the information conveyed in the LENGTH field is in units of octets. In an embodiment, the information to be encoded in the LENGTH field may be calculated as:
LENGTH=(duration)*(rate)*( 1,000,000/8) (8)
In equation (8), the units of the duration is in seconds and the units of the rate is in Mbps. The numerical constant ( 1,000,000/8) is employed to conform units. Specifically, the 1,000,000 factor converts Mbps to bps, and the ⅛ factor converts bits to octets. Note that the RATE field and the LENGTH field may contain fictitious values that may be unrelated to the actual number of octets in the message 300 or to the desirable data transmission rate. In the present embodiment, the information in the RATE field and the LENGTH field indicate the duration of the message 300 according to the first protocol to the device 102.

The method proceeds to block 406 where the header 302 is created. The RATE field and LENGTH field are provided the values determined or calculated above. In an embodiment, the SIG2 IND field is set to ‘1’ or ‘true’ to indicate that the header extension 304 is provided. In another embodiment, the stealth signal may be encoded in the header 302 to indicate that the header extension 304 is provided. The PARITY and TAIL fields are set following standard methods according to the first protocol.

The method proceeds to block 408 where the information to be encoded in the LENGTH2 field, the number of octets in the last symbol, is calculated. The device 110A or 110B knows the number of octets to be contained in the message 300, the desirable transmission rate (information that will be conveyed in the RATE2 field), and the duration of the message 300. In an embodiment, the information to be encoded in the LENGTH2 field, the number of octets in the last symbol, may be calculated as:

$$LENGTH2 = \{ SP \times RATE2 \} / 8 - \{ ( duration \times RATE2 ) ( 1 \text{,} 000 \text{,} 000 / 8 ) - total octets \} \qquad ( 9 )$$

In equation (9), the first term in the first pair of brackets corresponds to the octets per symbol period and the second term in the second pair of brackets corresponds to the number of empty or silent octets in the last symbol period. SP represents the duration of the symbol period expressed in units of μS. The RATE2 contains the desirable transmission rate expressed in units of Mbps. The duration is expressed in units of μS. The numerical constants ⅛ and ( 1,000,000/8) are employed to conform units. Specifically, the 1,000,000 factor converts Mbps to bps, and the ⅛ factors convert bits to octets.

The method proceeds to block 410 where the header extension 304 is created. The RATE2 field is assigned the value of the desirable transmission rate in Mbps, the LENGTH2 field is assigned the value calculated as above. The PARITY and TAIL fields are assigned values as discussed above.

The method proceeds to block 412 where the data 306 is created. The method proceeds to block 414 where the message 300, composed of the header 302, the header extension 304, and the data 306, is transmitted. In some embodiments, a signal extension 308 may be appended to the end of the message 306, as described above.

Note that other methods of performing the calculations describe above may readily occur to one skilled in the art, and all of these methods are contemplated by the present disclosure.

Turning now to FIG. 5, a flow chart of a method for receiving the message 300 according to one embodiment is depicted. In block 500, the device 110A or 110B decodes the header 302. The method proceeds to block 502 where, if the SIG2 IND bit in the header 302 is not set to ‘1’ or ‘true’, the method exits and alternate processing occurs. Alternate processing may involve receiving the message 300 formatted according to the first protocol.

In one embodiment if the SIG2 IND bit is set to ‘1’ or ‘true’, the method proceeds to block 504 where the duration of the message 300 is calculated based on the information contained in the RATE field and the LENGTH field. In an alternate embodiment, a stealth signal may be employed to indicate to the device 110A or 100B that the header extension 304 is present. In an embodiment, the duration in seconds may be calculated as:
duration=(LENGTH/RATE)*( 8/1,000,000) (10)
In equation (10), the information conveyed in the RATE field is expressed in units of Mbps and the information conveyed in the LENGTH field is expressed in units of octets. The numeric constant ( 8/1,000,000) is employed to conform units. Specifically, the 1/1,000,000 factor converts Mbps to bps, and the 8 factor converts octets to bits.

The method proceeds to block 506 where the header extension 304 is decoded. The method proceeds to block 508 where the number of octets of data to be read may be calculated, in an embodiment, as:
octets=(duration−SP/1,000,000)*(RATE2)*( 1,000,000/8)+LENGTH2 (11)
In equation (11), SP represents the duration of the symbol period expressed in units of μS. The information conveyed in the RATE2 field is expressed in units of Mbps and duration is expressed in units of seconds. The numeric constants 1/1,000,000 and ( 1,000,000/8) are employed to conform units. Specifically, the 1/1,000,000 factor converts μS to seconds, the 1,000,000 factor converts Mbps to bps, and the 8 factor converts bits to octets. The method proceeds to block 510 where the data is read based on the number of octets, and the method exits. Note that other methods of performing the calculations describe above may readily occur to one skilled in the art, and all of these methods are contemplated by the present disclosure.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown as directly coupled or communicating with each other may be coupled through some interface or device, such that the items may no longer be considered directly coupled to each but may still be indirectly coupled and in communication with one another. Other examples of changes, substitutions, and alterations are ascertainable by one skilled in the art and could be made without departing from the spirit and scope disclosed herein.

1. A system for wireless communication, comprising:
a first communication device operable to transmit a message according to a new protocol having a header including a first rate field and a first length field, a header extension including a second rate field and a second length field, and a data field, such that when the message is received by a legacy communication device operable to receive a portion of the message according to a legacy protocol, the legacy communication device refrains from transmitting for a duration indicated by the combination of the first rate field and the first length field; and
a second communication device operable to receive the message according to the new protocol.

2. The system of claim 1 wherein the new protocol is further defined as IEEE-802.11n and the legacy protocol is further defined as selected from the group of legacy protocols consisting of IEEE-802.11a and IEEE-802.11g.

3. The system of claim 1 wherein the duration is indicated by dividing a number of bits indicated by the first length field by a bits per second indicated by the first rate field, and wherein the number of bits is indicated by multiplying a number of octets encoded in the first length field by eight.

4. The system of claim 1 wherein the second length field indicates a number of octets in a last symbol period of the message and a combination of the second length field, the second rate field, and the duration are used by the second communication device to determine a structure of the message.

5. The system of claim 1 wherein the value of the second length field is derived by calculating the value of the number of octets in the message modulo an integer number, the integer number called a modulus, and wherein a combination of the second length field, the second rate field, and the duration are used by the second communication device to determine a length of the message.

6. The system of claim 1 wherein the first rate field and the first length field encode additional communication parameters according to the new protocol.

7. The system of claim 1 wherein the second length field provides a count of octets in a last symbol period of the data field.

8. The system of claim 1 wherein the first and second communication devices are further operable to reclaim one or more bits of the first length field for signaling purposes.

9. The system of claim 1 wherein the first and second communication devices are further operable to reclaim one or more bits of the first rate field for signaling purposes.

10. The system of claim 1 wherein the header includes a flag bit to indicate the presence of the header extension.

11. A system to enable improved wireless communication, the system comprising:
a first communication device operable to wirelessly communicate via a first protocol, the first protocol comprising:
a header portion including a first rate field and a first length field operable to indicate a duration of a message,
a header extension portion, including a second rate field and a second length field, wherein the second length field indicates the number of octets in a last symbol period of the message, and
a data portion containing an information content of the message;
a second communication device operable to communicate via a second protocol, the second communication device operable in response to receiving the message communicated according to the first protocol to refrain from transmitting for a duration indicated by a combination of the first rate field and the first length field; and
a third communication device operable to wirelessly communicate via the first protocol and to reclaim one or more bits from one of the first length field and first rate field for signaling purposes.

12. The system of claim 11 wherein the duration indicated by the combination of the first rate field and the first length field is based on the second protocol for calculating the duration.

13. The system of claim 11 and the header portion includes a reserved bit which is employed to indicate the presence of the header extension portion

14. The system of claim 13 wherein the second protocol is selected from the group of second protocols comprising an IEEE-802.11a standard and an IEEE-802.1 μg standard and wherein the header portion, header extension portion, data portion of the first protocol are based on an IEEE-802.11n standard.

15. A method of communicating to maintain compatibility with legacy devices, comprising:
creating a header extension containing a first rate field and a first length field of a message according to a first protocol;
creating a header containing a temporal length of the message according to a second protocol; and
sending the message including the header and the header extension to a first device operable to receive the message according to the first protocol and to a second device operable to receive at least a portion of the message according to the second protocol.

16. The method of claim 15 wherein the header includes a second rate field and a second length field, and wherein the temporal length of the message is indicated by combining information contained in the second rate field and the second length field.

17. The method of claim 15 wherein the message further includes a data field, and wherein the first length field indicates the number of octets in a last symbol period of the message.

18. The method of claim 15 wherein the message field further includes a data field, and wherein the first length field indicates the total number of octets in the message modulo a number.

19. The method of claim 15 wherein the temporal length of the message is used by the first device in combination with the first rate field and the first length field to determine a structure of the message, and wherein the temporal length indicates to the second device a duration during which to refrain from transmitting.

20. The method of claim 15 further comprising:
calculating a duration of the message by dividing a number of bits indicated by the first length field by a bits per second indicated by the first rate field, and wherein the number of bits is indicated by multiplying a number of octets encoded in the first length field by eight.
